(19) United States
(12) Patent Application Publication
(10) Pub. No.: US 2026/0045719 A1
(43) Pub. Date: Feb. 12, 2026

(54) Conductive Terminal and Electrical Connector

(71) Applicant: Tyco Electronics (Shanghai) Co., Ltd., Shanghai (CN)

(72) Inventors: Zhenyu (Richard) Chen, Shanghai (CN); Liming (Eric) Wang, Shanghai (CN); Jialin Zhang, Shanghai (CN); Xinxin (Daisy) Li, Shanghai (CN); Wende Zhao, Qingdao (CN); Shilong Wu, Qingdao (CN); Zebin (Donnie) Tang, Shanghai (CN); Yang (Leon) Zou, Shanghai (CN)

(73) Assignee: Tyco Electronics (Shanghai) Co., Ltd., Shanghai (CN)

(21) Appl. No.: 19/294,408

(22) Filed: Aug. 8, 2025

(30) Foreign Application Priority Data
Aug. 8, 2024 (CN) 202411089811.3

(51) Int. Cl. H01R 13/03; C25D 3/12; C25D 3/46; C25D 3/48; C25D 3/50; C25D 5/12; C25D 5/16

(52) U.S. Cl. CPC H01R 13/03; C25D 3/12; C25D 3/46; C25D 3/48; C25D 3/50; C25D 5/12; C25D 5/16

(57) ABSTRACT

A conductive terminal, comprising a conductive substrate. The conductive terminal further includes an electroplating layer structure plated on the conductive substrate, the electroplating layer structure comprises: a nickel plating layer located outside the conductive substrate. The electroplating layer structure further comprises a silver plating layer located outside the nickel plating layer. The electroplating layer structure further comprises a noble metal plating layer located outside the silver plating layer.

### CROSS-REFERENCE TO RELATED APPLICATIONS

This application claims the benefit of Chinese Patent Application No. CN 202411089811.3 filed on Aug. 8, 2024 in the State Intellectual Property Office of China, the whole disclosure of which is incorporated herein by reference.

### FIELD OF THE INVENTION

The present invention relates to the field of electroplating, and in particular, to a conductive terminal and an electrical connector.

### BACKGROUND

An electrical connector may be used to transmit data signals and/or electrical energy. The electrical connector includes mating conductive terminals that apply positive pressure to each other to maintain good contact. During use, the conductive terminals will have relative micro-motions at the contact due to thermal expansion and vibration, resulting in localized wear. In addition, when the electrical connector needs to be subjected to a large amount of repetitive plugging and unplugging, it will cause the electrical contacts of the conductive terminals to wear out due to friction.

Gold and silver are increasingly commonly used in electrical contacts of conductive terminals due to market demand for high current and multi-plug applications. The gold is resistant to high temperature and humidity, and is not corroded by any acid or alkali except aqua regia. Silver is cheaper than gold, and its thermal and electrical conductivity is more suitable for coating electrical contacts or for pure chemical or electrochemical deposition on electrical contacts. However, the hardness of silver, 100 HV, is significantly lower than the hardness of gold, 180 HV, so the wear resistance of the silver-plated conductive terminal is lower. Moreover, since silver is not resistant to any acid or alkali corrosion, it is prone to oxidize and sulfide in warm and wet, coastal or industrial waste exhaust environments, making the electrical performance of the conductive terminal decrease or even fail.

### SUMMARY

A conductive terminal, comprising a conductive substrate. The conductive terminal further includes an electroplating layer structure plated on the conductive substrate, the electroplating layer structure comprises: a nickel plating layer located outside the conductive substrate. The electroplating layer structure further comprises a silver plating layer located outside the nickel plating layer. The electroplating layer structure further comprises a noble metal plating layer located outside the silver plating layer.

### BRIEF DESCRIPTION OF DRAWINGS

In the following, the present invention is described in more detail with references to the drawings in which:

FIG. 1 is a schematic diagram of the structure of a conductive terminal according to an example of this present disclosure;

FIG. 2 is a schematic diagram of the structure of a conductive terminal according to an example of this present disclosure;

FIG. 3 is a schematic diagram of the structure of a conductive terminal according to an example of this present disclosure;

FIG. 4 is a schematic diagram of the structure of a conductive terminal according to an example of this present disclosure; and

FIG. 5 is a schematic diagram of the structure of a conductive terminal according to an example of this present disclosure.

### DETAILED DESCRIPTION OF THE EMBODIMENTS

The following further describes the technical solutions of this present disclosure in detail with reference to the accompanying drawings by using examples. In the specification, the same or similar reference signs indicate the same or similar components. The following description of the embodiments of the present disclosure with reference to the accompanying drawings is intended to explain the general inventive concept of the present disclosure, and should not be construed as limiting the present disclosure.

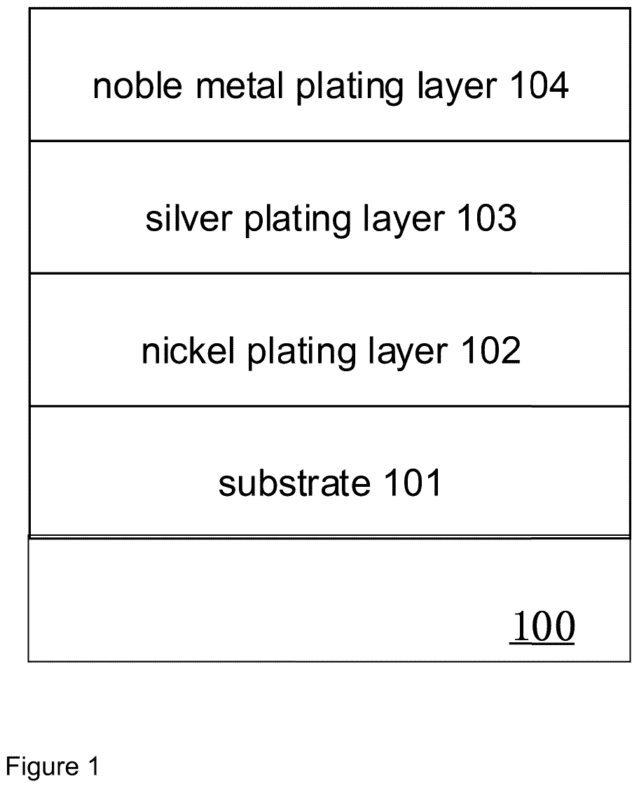

FIG. 1 shows a schematic diagram of the structure of a conductive terminal according to an exemplary embodiment of the present disclosure. The conductive terminal 100 includes a conductive substrate 101 and an electroplating layer structure plated on the conductive substrate. The electroplating layer structure includes a nickel plating layer 102 located outside the conductive substrate 101, a silver plating layer 103 located outside the nickel plating layer 102, and a noble metal plating layer 104 located outside the silver plating layer 103.

In an exemplary embodiment, the conductive substrate 101 is made of copper or a copper alloy. The copper alloy includes, but not limited to, brass and bronze. The nickel plating layer 102 is disposed between the conductive substrate 101 and the silver plating layer 103. The nickel plating layer 102 may act as a barrier to prevent copper diffusion into the silver plating layer at high temperatures. In addition, the nickel plating layer 102 also retains the electrical properties of the silver. The nickel plating layer 102 has a thickness of at least 0.5 μm, or such as from 1 μm to 10 μm, or such as from 1.27 μm to 3 μm. The nickel plating layer 102 may be formed in a variety of ways including, but not limited to, PVD, CVD, and electrolysis etc.

In the exemplary embodiment, the “friction coefficient” is calculated as the friction divided by the vertical or normal force. During the test of the friction coefficient, a force perpendicular to the direction of relative motion between two samples is applied between the two samples. The friction coefficient is obtained by measuring the friction between the two samples. The friction coefficient of the silver plating layer 103 may be less than 1.

In the exemplary embodiment, a “hard silver alloy”, such as a silver-antimony alloy, a silver-tin alloy, or a silver-palladium alloy, may be used to improve the hardness of silver. The hardness of the hard silver alloy may reach 150 Hv. The friction coefficient of the hard silver alloy was approximately 1.2-1.6 under a testing condition of 100 linear cycles under 1 N load. In addition, wear marks are shown on the surface of the hard silver alloy, and the wear depth is about 2-4 μm.

In the exemplary embodiment, the silver plating layer 103 of the present disclosure has a friction coefficient of less than 1, more preferably between 0.25-0.5, under test conditions of 500-10000 linear cycles under 1-5N loads. For example, the friction coefficient of the silver plating layer 103 may be 0.4 under a test condition of 1000 linear cycles under 2N load. In addition, the surface of the silver plating layer 103 is substantially flat, that is, there are almost no wear marks. The performance of the silver plating layer with a friction coefficient less than 1 is much better than that of the hard silver alloy. By contrast, the friction coefficient of hard gold under test conditions of 500-10000 linear cycles under 1 N load was approximately 0.5-1.

It should be noted that the above friction coefficients are measured without lubricant on the surface of the metal layer. Since the silver plating layer of the present disclosure has self-lubricity, there may be no need to add an organic transparent film or lubricant to the surface after plating is completed. Therefore, the production process is simple, controllable, stable, and relatively low in cost.

In the exemplary embodiment, the silver plating layer 103 is formed by electroplating the substrate in a silver electroplating bath. In some examples, the silver electroplating bath includes a silver ion source, thiodiethanol, and a sulfonated anionic polymer. In some examples, the pH of the silver electroplating bath is less than 7. Preferably, the pH is 0-3.

In the exemplary embodiment, the silver electroplating bath does not include cyanide. The silver ion may be provided by a silver salt, including a mixture of one or more of silver halide, silver gluconate, silver citrate, silver lactate, silver nitrate, silver sulfate, silver alkyl sulfonate, and silver alkanol sulfonate. The preparation of the silver plating layer does not require a cyanide solvent, so there is no need to specifically control the highly toxic material, and the harm to the environment is reduced. The silver electroplating bath may be SilveronTMGT-101, SilveronTMGT-210, or SilveronTMGT-820 from DuPont.

In the exemplary embodiment, the silver electroplating layer 103 has a thickness of at least 2 μm, or such as from 2 μm to 10 μm, or such as from 2.5 μm to 5 μm.

In the exemplary embodiment, the noble metal plating layer 104 covering the silver plating layer can improve the anti-corrosion performance of the conductive terminal. In some exemplary embodiments, the noble metal plating layer may include one or more of gold, platinum, and ruthenium. For example, the noble metal plating layer 104 may be hard gold, platinum, or platinum-ruthenium alloy. In some exemplary embodiments, the thickness of the noble metal plating layer is in the nanometer level, preferably 0.1 μm.

In the exemplary embodiment, when the noble metal plating layer 104 includes platinum, wear resistance and stability of the terminal are improved. First, platinum (min 450 Hv) has a higher hardness than gold (180 Hv), which is beneficial to improve the anti-wear performance of the terminal. Moreover, the cost of platinum is about 50% of gold, which can significantly reduce the production cost of the electrical connector. Secondly, the color and gloss of platinum are close to those of silver, which is beneficial to improve the surface gloss of the terminal and reduce discoloration. In addition, the density of platinum (21.45 g/cm3) is higher than that of gold (19.3 g/cm3), and it is easier to obtain a dense nanocrystalline structure by electroplating. For the same thin nano-thickness plating, platinum's densification and covering ability are better than gold, which can enhance the corrosion resistance for the silver plating layer.

In the exemplary embodiment, the conductive terminal 100 in FIG. 1 can replace the hard silver alloy in the prior art with a silver plating structure with a low friction coefficient, which can significantly improve the wear resistance of the conductive terminal. In addition, the silver plating structure can replace expensive gold, thereby reducing costs. In addition, the noble metal plating layer outside the silver plating layer can reduce corrosion and discoloration of the silver plating layer, thereby improving the stability of the conductive terminal.

In the exemplary embodiment, carbon particles, such as graphite, other carbon allotropes, or mixtures thereof, may be added uniformly in silver in order to improve the wear resistance of the silver plating layer. In some examples, the silver plating layer 103 of the present disclosure does not include carbon particles having a grain size greater than 100 nm in diameter, and the mass percentage of carbon in the silver plating layer is 1-3%. In this way, the poor contact stability between silver and carbon particles and uneven thickness of the silver plating layer can be avoided.

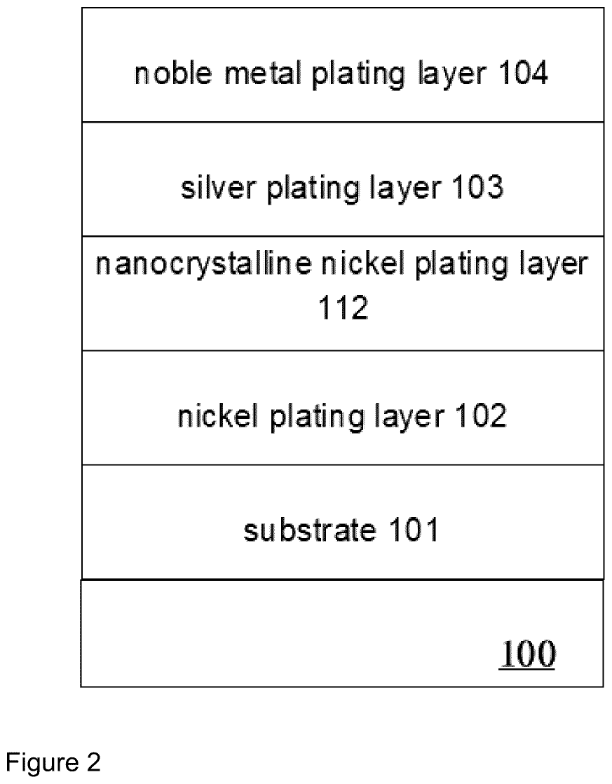

In the exemplary embodiment and as shown in FIG. 2, a schematic diagram of the structure of a conductive terminal according to an example of the present disclosure. The conductive terminal 100 includes a conductive substrate 101 and an electroplating layer structure plated on the conductive substrate. The electroplating layer structure includes a nickel plating layer 102 located outside the conductive substrate 101, a silver plating layer 103 located outside the nickel plating layer 102, a nanocrystalline nickel plating layer 112 located between the nickel plating layer 102 and the silver plating layer 103, and a noble metal plating layer 104 located outside the silver plating layer 103. The silver plating layer 103's friction coefficient is less than 1.

In the exemplary embodiment, the nanocrystalline nickel plating layer 112 between the nickel plating layer 102 and the silver plating layer 103 can increase the densification and the bonding force between the plating layers.

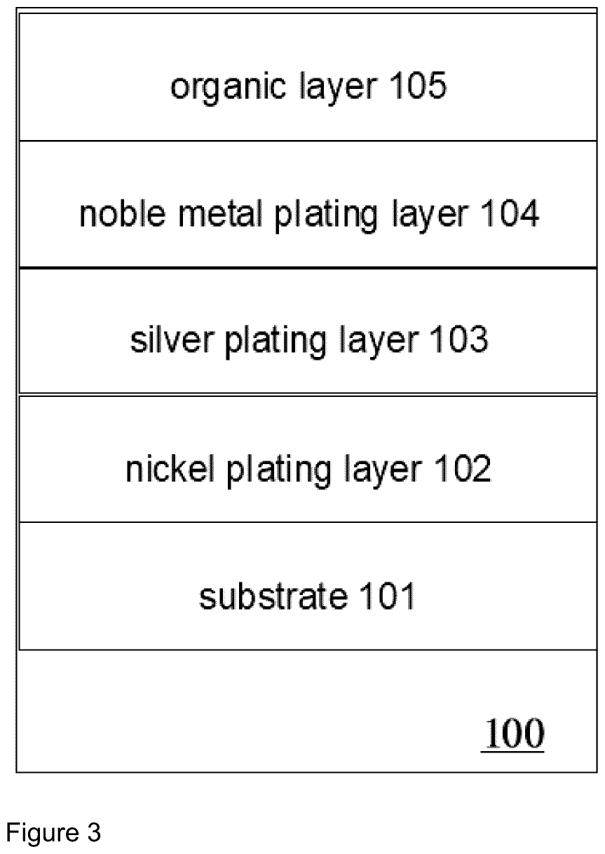

In the exemplary embodiment, FIG. 3 shows a schematic diagram of the structure of a conductive terminal according to an example of this present disclosure. The conductive terminal 100 includes a conductive substrate 101 and an electroplating layer structure plated on the conductive substrate. The electroplating layer structure includes a nickel plating layer 102 located outside the conductive substrate 101, a silver plating 103 located outside the nickel plating layer 102, a noble metal plating layer 104 located outside the silver plating layer 103, and an organic layer 105 located outside the noble metal plating layer 104. The silver plating layer 103's friction coefficient is less than 1.

In the exemplary embodiment, the organic layer 105 covers the outermost side of the electroplating layer structure, and acts as a lubricant and sealer to reduce corrosion, wear, and discoloration of the silver plating layer. The organic layer 105 may optionally be a lubricating oil containing organic materials such as thiol, perfluoro, olefin, or polyether.

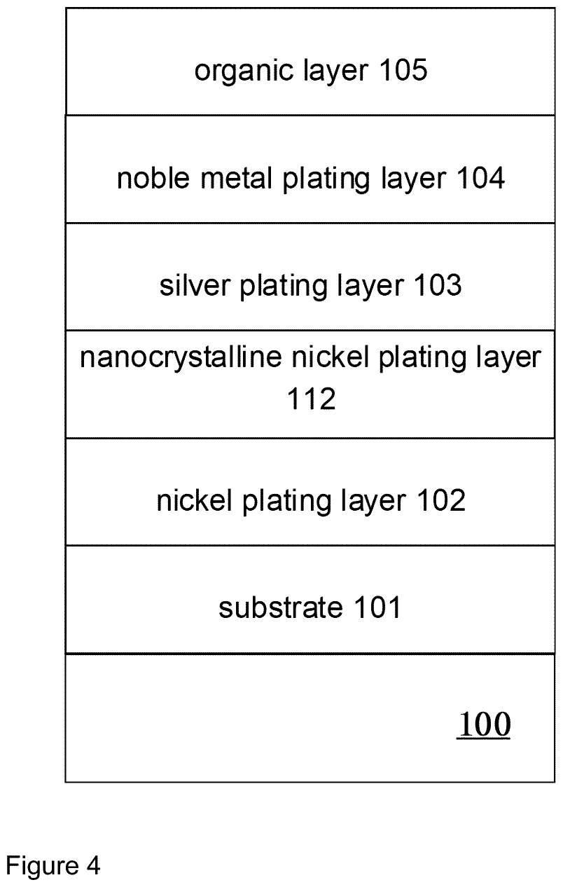

In the exemplary embodiment, FIG. 4 shows a schematic diagram of the structure of a conductive terminal according to an example of the present disclosure. The example in FIG. 4 incorporates the structures of the conductive terminals in FIG. 2 and FIG. 3. Specifically, the conductive terminal 100 includes a conductive substrate 101 and an electroplating layer structure plated on the conductive substrate. The electroplating layer structure includes a nickel plating layer 102 located outside the conductive substrate 101, a silver plating layer 103 located outside the nickel plating layer 102, a nanocrystalline nickel plating layer 112 located between the nickel plating layer 102 and the silver plating layer 103, a noble metal plating layer 104 located outside the silver plating layer 103, and an organic layer 105 located on the outside the electroplating layer structure. The silver plating layer 103's friction coefficient is less than 1.

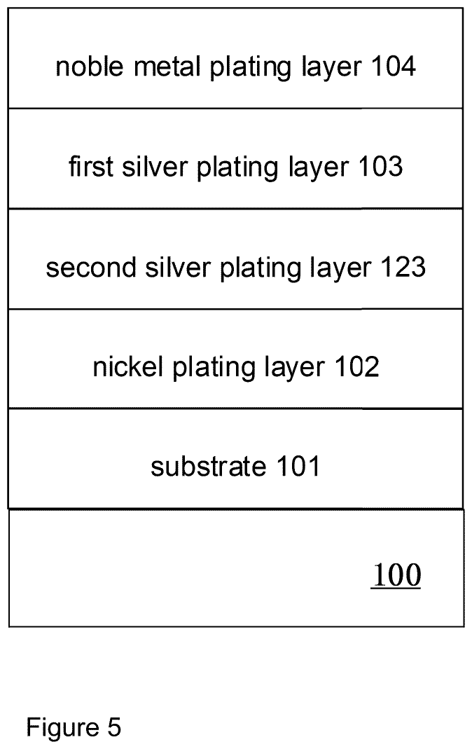

In the exemplary embodiment, FIG. 5 shows a schematic diagram of the structure of a conductive terminal according to an example of the present disclosure. Compared with the structure in FIG. 1, a second silver plating layer 123 is disposed between the nickel plating layer 102 and the silver plating layer 103 in FIG. 5. Specifically, the conductive terminal 100 includes a conductive substrate 101 and an electroplating layer structure plated on the conductive substrate. The electroplating layer structure includes a nickel plating layer 102 located outside the conductive substrate 101, a second silver plating layer 123 located outside the nickel plating layer 102, a first silver plating layer 103 located outside the second silver plating layer, and a noble metal plating layer 104 located outside the first silver plating layer 103. The silver plating layer 103's friction coefficient is less than 1.

In the exemplary embodiments, the second silver plating layer 123 may be in a nanocrystalline structure. The second silver plating layer, located between the nickel plating layer 102 and the first silver plating layer 103, can increase the densification and the bonding force between the plating layers, thus reducing heat diffusion and thermal expansion of the metal caused by temperature rise when the connector is energized for a long time.

In the exemplary embodiment, an electrical connector which employs any one of the conductive terminals as described above. The conductive terminal of this example has the same or similar structure as the preceding examples, so it will not be repeated.

The foregoing descriptions are merely optional examples of this present disclosure, and are not intended to limit the examples of this present disclosure. Various modifications and changes may be made to the examples of this present disclosure by a person skilled in the art. Any modification, equivalent replacement, or improvement made without departing from the spirit and principle of the examples of this present disclosure shall be included in the protection of the examples of this present disclosure.

Although the examples of this present disclosure have been described with reference to several specific examples, it should be understood that the examples of the present disclosure are not limited to the disclosed specific examples. The examples of this present disclosure are intended to cover various modifications and equivalent arrangements included within the spirit and scope of the appended claims. The scope of the appended claims is to be accorded the broadest interpretation so as to encompass all such modifications and equivalent structures and functions.

What is claimed is:

1. A conductive terminal, comprising:
a conductive substrate;
an electroplating layer structure plated on the conductive substrate, the electroplating layer structure comprises:
a nickel plating layer located outside the conductive substrate;
a silver plating layer located outside the nickel plating layer; and
a noble metal plating layer located outside the silver plating layer.

2. The conductive terminal of claim 1, wherein a friction coefficient of the silver plating layer is less than 1.

3. The conductive terminal of claim 1, further comprising a nanocrystalline nickel plating layer located between the nickel plating layer and the silver plating layer.

4. The conductive terminal of claim 1, further comprising a lubricating layer covering an outermost side of the electroplating layer structure.

5. The conductive terminal of claim 1, wherein the silver plating layer is a first silver plating layer, and the electroplating layer structure further comprises a second silver plating layer, wherein the second silver plating layer is located between the nickel plating layer and the first silver plating layer.

6. The conductive terminal of claim 2, wherein the friction coefficient of the silver plating layer is within a range of 0.25-0.5.

7. The conductive terminal of claim 1, wherein a thickness of the silver plating layer, ranges from 2.5 μm to 5 μm.

8. The conductive terminal of claim 1, wherein the silver plating layer is formed by electroplating in a silver electroplating bath, and a pH of the silver electroplating bath is less than 7.

9. The conductive terminal of claim 8, wherein the silver electroplating bath is free of cyanide.

10. The conductive terminal of claim 8, wherein the silver plating layer has carbon particles with a grain size less than 100 nm in diameter, and a mass percentage of carbon in the silver plating layer is 1-3%.

11. The conductive terminal of claim 1, wherein the noble metal plating layer comprises one or more of metallic gold, platinum, and ruthenium.

12. The conductive terminal of claim 1, wherein the noble metal plating layer has a thickness of 0.1 μm.

13. The conductive terminal of claim 1, wherein the nickel plating layer has a thickness of 1.27 μm to 3 μm.

14. An electrical connector, comprising:
a conductive terminal having:
a conductive substrate;
an electroplating layer structure plated on the conductive substrate, the electroplating layer structure comprises:
a nickel plating layer located outside the conductive substrate, a friction coefficient of a silver plating layer is less than 1, the silver plating layer is a first silver plating layer, and the electroplating layer structure further includes a second silver plating layer, the second silver plating layer is located between the nickel plating layer and the first silver plating layer;
the silver plating layer located outside the nickel plating layer;
a nanocrystalline nickel plating layer located between the nickel plating layer and the silver plating layer;
a lubricating layer covering an outermost side of the electroplating layer structure; and
a noble metal plating layer located outside the silver plating layer.

15. The conductive terminal of claim 14, wherein the friction coefficient of the silver plating layer is within a range of 0.25-0.5.

16. The conductive terminal of claim 14, wherein a thickness of the silver plating layer, ranges from 2.5 μm to 5 μm.

17. The conductive terminal of claim 14, wherein the silver plating layer is formed by electroplating in a silver electroplating bath, and a pH of the silver electroplating bath is less than 7.

18. The conductive terminal of claim 17, wherein the silver electroplating bath is free of cyanide.

19. The conductive terminal of claim 18, wherein the silver plating layer has carbon particles with a grain size less than 100 nm in diameter, and a mass percentage of carbon in the silver plating layer is 1-3%.

20. The conductive terminal of claim 14, wherein the noble metal plating layer has a thickness of 0.1 μm.
